(19) United States
(12) Patent Application Publication
(10) Pub. No.: US 2006/0225469 A1
(43) Pub. Date: Oct. 12, 2006

(54) Padlock with block member

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/448,088

(22) Filed: Jun. 7, 2006

Related U.S. Application Data
(63) Continuation-in-part of application No. 10/671,659, filed on Sep. 29, 2003.

(51) Int. Cl. E05B 37/02

(52) U.S. Cl. 70/21

(57) ABSTRACT

A padlock comprises a lock body, a shackle, a block member, a combination locking device, and a key locking device. The shackle is movable relative to the lock body between a locked position and an unlocked position, and has a longer arm movably installed in the lock body and a shorter arm. The block member is movably connected to the lock body and comprises an engaging portion for retaining the shorter arm of the shackle in the locked position and a mounting portion installed in the lock body. Furthermore, the engaging portion has a receptacle for receiving an end of the shorter arm and a gap formed on an edge of the engaging portion and communicated with the receptacle. The combination locking device is installed in the lock body and comprising a stem connected to the mounting portion of the block member. The shorter arm of the shackle is movable to the unlocked position when the combination locking device is unlocked. The key locking device is installed in the lock body and comprises a retaining block engageable with the longer arm of the shackle and a locking unit connected with the retaining block. The longer arm of the shackle is movable to allow the shorter arm of the shackle moving to the unlocked position when the locking unit is operated by a key.

### CROSS REFERENCE

This is a continuation application of the co-pending U.S. Ser. No. 10/671,659 application, filed on Sep. 29, 2003.

### TECHNICAL FIELD

This invention relates generally to a padlock, in particular, to a padlock with a block member and two locking devices, whereby the padlock can be unlocked or locked by either one of the locking devices.

### BACKGROUND OF THE INVENTION

A conventional padlock generally includes a lock body, a locking device and a shackle so as to lock an object, as disclosed in U.S. Pat. Nos. 4,751,830 and 6,539,761. Another conventional padlock not only includes a lock body, a dual locking device and a shackle, but also includes a block member to retain or to release the shackle, also as disclosed in U.S. Pat. No. 6,848,283 and U.S. Patent Publication Nos. 2002/0088256, 2004/0226323 and 2004/0226324. The block member of the conventional padlock is mainly arranged for the dual locking device, especially for a key locking device as so to controlling movements of the shackle. However, connections between the block member and the dual locking device are arranged to be complicated. Therefore, an improved padlock is in great demand.

### SUMMARY OF INVENTION

It is therefore an object of the present invention to provide a padlock, which has a block member and two locking devices.

More specifically, the padlock of the present invention comprises a lock body, a shackle, a block member, a combination locking device, and a key locking device. The shackle is movable relative to the lock body between a locked position and an unlocked position, and has a longer arm movably installed in the lock body and a shorter arm; furthermore, the longer arm has a flange at an end thereof. The block member is movably connected to the lock body and comprises an engaging portion for retaining the shorter arm of the shackle in the locked position and a mounting portion installed in the lock body. The engaging portion has a receptacle therein for receiving an end of the shorter arm and a gap formed on an edge of the engaging portion and communicated with the receptacle. The mounting portion has a protrusion thereon.

Additionally, the combination locking device is installed in the lock body and comprises a stem connected to the mounting portion of the block member. The stem has a recess at a top thereof for receiving the mounting portion and a concave communicated with the recess for engaging with the protrusion of the mounting portion. The shorter arm of the shackle is movable to the unlocked position when the combination locking device is unlocked. The key locking device is installed in the lock body and comprises a retaining block engageable with the flange of the longer arm of the shackle and a locking unit connected with the retaining block. The longer arm of the shackle is movable to allow the shorter arm of the shackle moving to the unlocked position when the locking unit is operated by a key.

### BRIEF DESCRIPTION OF DRAWINGS

The invention will be more clearly understood after referring to the following detailed description read in conjunction with the drawings wherein:

FIG. 1 is a perspective view of a padlock as a preferred embodiment of the present invention;

FIG. 2 is a cross sectional view of the padlock, showing a shackle of the padlock being in a locked position;

FIG. 3 is a perspective view of a block member and a stem of the present invention;

FIG. 4 is a perspective view of the padlock, showing the shackle is moved to an unlocked position after a combination locking device is unlocked;

FIG. 5 is a cross sectional view of the padlock, as shown in FIG. 4;

FIG. 6 is a cross sectional view of a rotor and a bump of the present invention, showing the rotor being connected to the bump; and

FIG. 7 is a cross sectional view of the rotor and the bump of the present invention, showing the rotor being rotated to drive the bump moving.

### DETAILED DESCRIPTION OF PREFERRED EMBODIMENTS

FIGS. 1-7 show a padlock as a preferred embodiment of the present invention. In FIGS. 1-3, the padlock comprises a lock body 1, a shackle 2, a block member 3, a key locking device 4 and a combination locking device 5. The shackle 2 is movable relative to the lock body 1 between a locked position and an unlocked position, and has a longer arm 20 movably installed in the lock body 1 and a shorter arm 21; furthermore, the longer arm 20 has a flange 22 at an end thereof.

The block member 3 is movably connected to the lock body 1 and comprises an engaging portion 30 for retaining the shorter arm 21 of the shackle 2 in the locked position and a mounting portion 31 installed in the lock body 1. The engaging portion 30 has a receptacle 32 therein for receiving an end of the shorter arm 21 and a gap 33 formed on an edge of the engaging portion 30 and communicated with the receptacle 32. Preferably, the gap 33 has a width larger than a diameter of the shorter arm 21 of the shackle 2. Additionally, the mounting portion 31 has a protrusion 34 thereon.

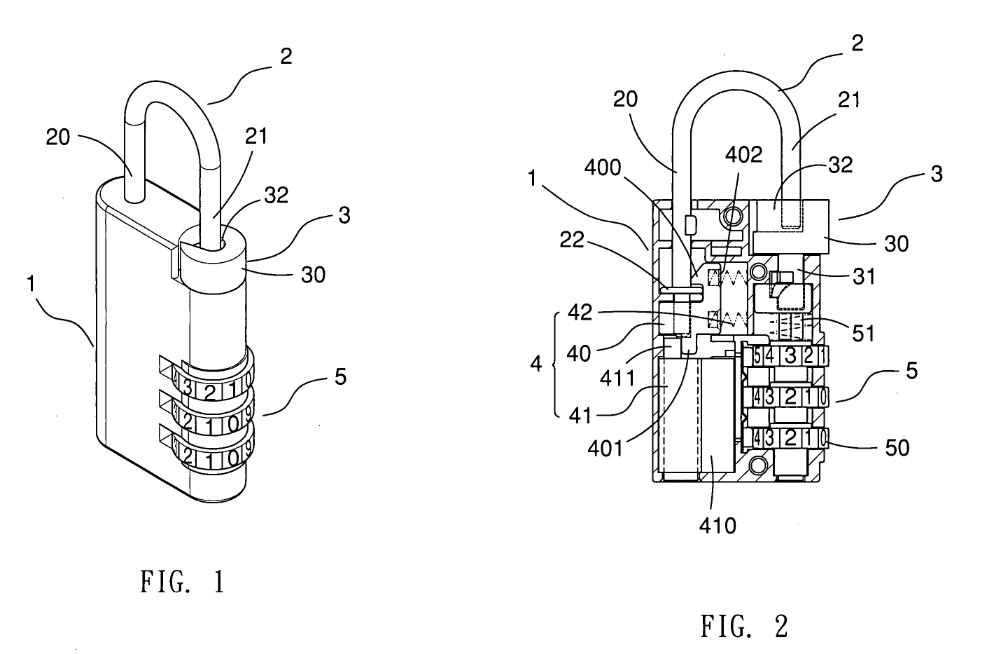

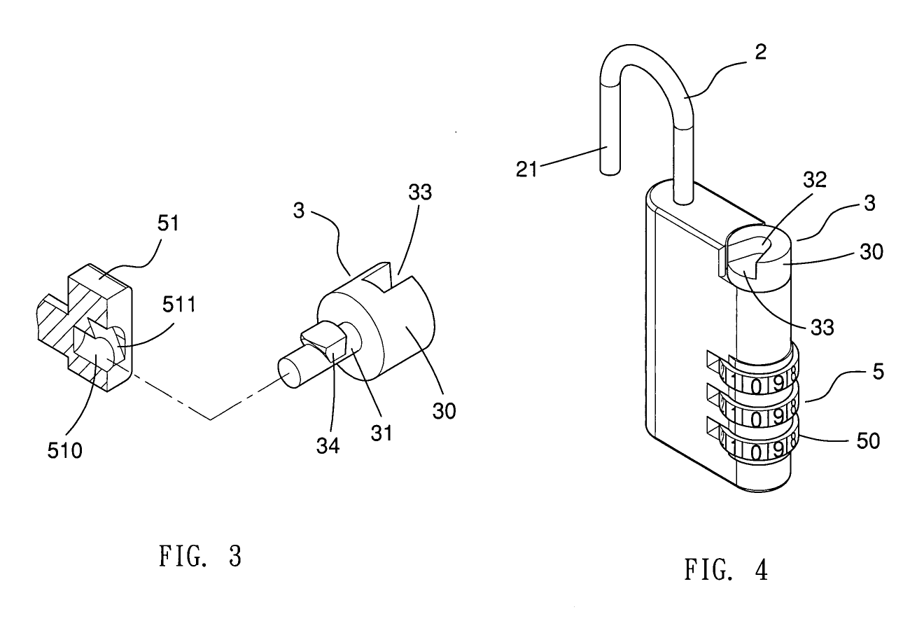

As shown in FIGS. 2 and 3, the combination locking device 5 is installed in the lock body 1 and comprises numeral wheels 50 and a stem 51, which is connected to the mounting portion 31 of the block member 3. The shorter arm 21 of the shackle 2 is movable to the unlocked position when the combination locking device 5 is unlocked, namely, when a set of unlocking codes to the numeral wheels 50 are dialed. In FIG. 3, the stem 51 has a recess 510 at a top thereof for receiving the mounting portion 31 and a concave 511 communicated with the recess 510 for engaging with the protrusion 34 of the mounting portion 31. Therefore, the mounting portion 31 is installed in the recess 510 and the protrusion 34 is engaged with the concave 511 to further prevent the engaging portion 30 from moving when the padlock is locked. Additionally, when the combination locking device 5 is locked, the block member 3 is unmovable via the connections between the stem 51 and the mounting portion 31.

FIG. 2 shows that the key locking device 4 is also installed in the lock body 1, and comprises a retaining block 40 engageable with the flange 22 of the longer arm 20 of the shackle 2, a locking unit 41 connected with the retaining block 40, and springs 42 connected with the retaining block 40. The longer arm 20 of the shackle 2 is movable to allow the shorter arm 21 of the shackle 2 moving to the unlocked position when the locking unit 41 is operated by a specific key (not shown), such as a unique key possessed by an official or inspector. Furthermore, the retaining block 40 has a hook 401 on a top of the retaining block 40 for engaging with the flange 22 of the longer arm 20 of the shackle 2, a bump 401 on a bottom of the retaining block 40, and holes 402 on a wall of the retaining block 40 for connecting with the springs 42 respectively. Each spring 42 has one end installed in the respective hole 402 and the other end connected with the lock body 1, so as to provide a bounce. The locking unit 41 comprises a body 410 and a rotor 411 installed in the body 410, the rotor 411 having a first end for receiving the key and a second end extending from the body 410 and connected to the bump 401 of the retaining block 40 for driving the retaining block 40. Preferably, the send end of the rotor 411 is shaped as a hemi-cylinder.

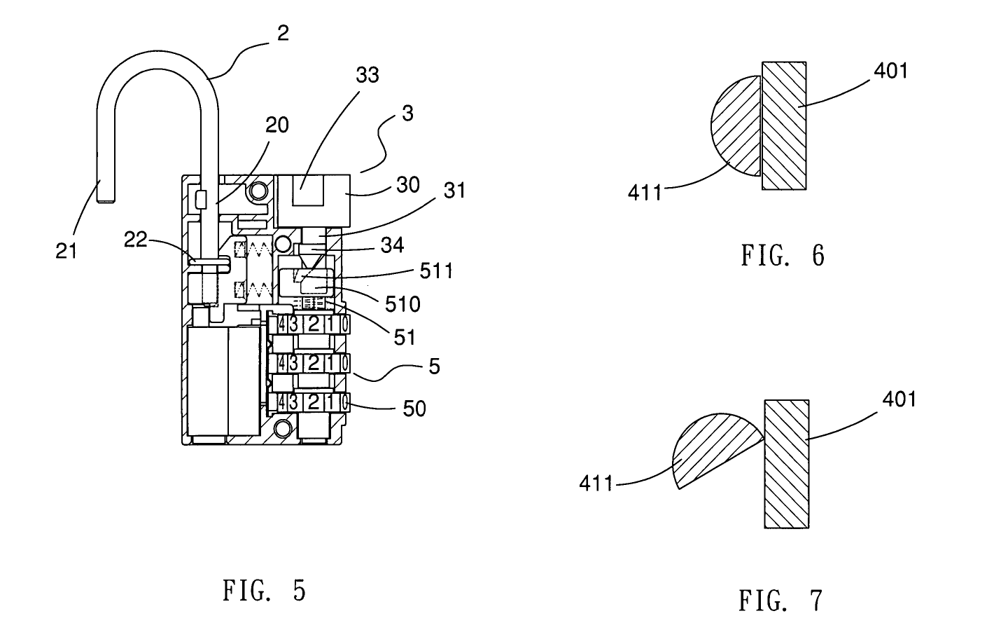

In FIGS. 4 and 5, the padlock of the present invention is unlocked, and the shackle 2 is moved to the unlocked position after the combination locking device 5 is unlocked by dialing the unlocking codes to the numeral wheels 50. More specifically, as shown in FIG. 5, when the combination locking device 5 is unlocked, the stem 51 is moved downwardly to release the mounting portion 31, namely the protrusion 34 disengaged with the concave 511, so as to allow the engaging portion 30 of the block member 3 rotating to a position where the shorter arm 21 of the shackle 2 can be moved from the receptacle 32 of the engaging portion 30 through passing by the gap 33. Accordingly, for the purposes of relocking the padlock, the shorter arm 21 of the shackle 2 can be moved back to the receptacle 21 via the gap 33, and the engaging portion 30 of the block member 3 can be rotated back to the original locked position where the shorter arm 21 cannot be moved from the block member 3 next, as shown in FIG. 1.

FIGS. 6 and 7 show the connections between the rotor 411 of the locking unit 41 and the bump 401 of the retaining block 40. When the padlock is locked by the key locking device 4, the second end of the rotor 411 is connected against to the bump 401, as shown in FIG. 6, and the flange 22 of the longer arm 20 of the shackle 2 is engaged with the hook 400 of the retaining block 40 for restricting the shackle 2 from moving, as further shown in FIG. 2. FIG. 7 further shows that the second end of the rotor 411 is driven by the key and rotated accordingly to push the bump 401 moving to a position where allows the longer arm 20 moving. Therefore, when the padlock is unlocked by the key locking device 4, the retaining block 40 is moved to allow the hook 400 moving away from the flange 22 and to restore the bounce via the springs 42. Accordingly, the longer arm 20 of the shackle 2 is movable upwardly to further allow the short arm 21 of shackle 2 moving from the block member 3. Accordingly, for the purposes of relocking the padlock, when the shorter arm 21 is moved back into the block member 3, the rotor 411 can be driven and rotated to allow the bump 401 returning to its original locked position via the bounce to the retaining block 40 so as to have the hook 400 engaged with the flange 22.

Numerous characteristics and advantages of the invention have been set forth in the foregoing description, together with details of the stricture and function of the invention, and the novel features thereof are pointed out in appended claims. The disclosure, however, is illustrative only, and changes may be made in detail, especially, in matters of shape, size and arrangement of parts, materials and the combination thereof within the principle of the invention, to the full extent indicated by the broad general meaning of the terms in which the appended claims are expressed.

We claim:

1. A padlock comprising:
a lock body;
a shackle, movable relative to the lock body between a locked position and an unlocked position, the shackle having a longer arm movably installed in the lock body and a shorter arm, wherein the longer arm has a flange at an end thereof;
a block member, movably connected to the lock body and comprising an engaging portion for retaining the shorter arm of the shackle in the locked position and a mounting portion installed in the lock body, wherein the engaging portion has a receptacle therein for receiving an end of the shorter arm and a gap formed on an edge of the engaging portion and communicated with the receptacle, and wherein the mounting portion has a protrusion thereon;
a combination locking device, installed in the lock body and comprising a stem connected to the mounting portion of the block member, wherein the stem has a recess at a top thereof for receiving the mounting portion and a concave communicated with the recess for engaging with the protrusion of the mounting portion, and wherein the shorter arm of the shackle is movable to the unlocked position when the combination locking device is unlocked; and
a key locking device, installed in the lock body and comprising a retaining block engageable with the flange of the longer arm of the shackle and a locking unit connected with the retaining block, wherein the longer arm of the shackle is movable to allow the shorter arm of the shackle moving to the unlocked position when the locking unit is operated by a key.

2. The padlock of claim 1, wherein the retaining block of the key locking device has a hook on a top of the retaining block for engaging with the flange of the longer arm of the shackle and a bump on a bottom of the retaining block, and wherein locking unit comprises a body and a rotor installed in the body, the rotor having a first end for receiving the key and a second end extending from the body and connected to the bump of the retaining block.

3. The padlock of claim 2, wherein the key locking device further comprises at least one spring and the retaining block of the key locking device further has at least one hole on a wall of the retaining block for connecting with the at least one spring, wherein the at least one spring has one end installed in the at least one hole and has the other end connected with the lock body.
